(19) United States
(12) Patent Application Publication
(10) Pub. No.: US 2024/0156663 A1
(43) Pub. Date: May 16, 2024

(54) Smart Digital Touchscreen Keepsake Memorialization Cremation Urn Device

(71) Applicant: Mykiea Miller, Mobile, AL (US)

(72) Inventor: Mykiea Miller, Mobile, AL (US)

(21) Appl. No.: 18/504,225

(22) Filed: Nov. 8, 2023

Related U.S. Application Data
(60) Provisional application No. 63/424,170, filed on Nov. 10, 2022.
(60) Provisional application No. 63/436,994, filed on Jan. 4, 2023.

(51) Int. Cl. A61G 17/08; G06F 3/041; G06F 3/16; G07C 9/00

(52) U.S. Cl. CPC A61G 17/08; G06F 3/041; G06F 3/16; G07C 9/00896

(57) ABSTRACT

A smart digital touchscreen keepsake memorialization cremation urn device is provided. The device provides an improved burial urn that is comprised of a digital display screen that can display media such as photos, videos, etc. and play songs and recordings via a speaker. The media can be transferred to the device via a physical memory card or may be wirelessly transferred via a mobile application.

### CROSS-REFERENCE TO RELATED APPLICATIONS

The present application claims priority to, and the benefit of, U.S. Provisional Application No. 63/424,170, filed on Nov. 10, 2022, and U.S. Provisional Application No. 63/436,994, filed on Jan. 4, 2023, and are incorporated herein by reference in its entirety.

### FIELD OF THE INVENTION

The present invention relates generally to the field of burial urns. More specifically, the present invention relates to a smart urn that can display photos, videos, recordings, etc., on a display located on the device. Accordingly, the present disclosure makes specific reference thereto. Nonetheless, it is to be appreciated that aspects of the present invention are also equally applicable to other like applications, devices, and methods of manufacture.

### BACKGROUND

A burial urn is used to store cremated ashes inside the urn. However, the design of burial urns has remained relatively unchanged since they have been created. This may provide for a burial urn with a boring or uninspiring appearance.

Therefore, there exists a long-felt need in the art for an improved burial urn. There also exists a long-felt need in the art for a burial urn with an improved appearance and modern design. Further, there exists a long-felt need in the art for an improved burial urn that is equipped with modern smart features such as, but not limited to, mobile application control and electronic display screens. More specifically, there exists a long-felt need in the art for a smart digital touchscreen keepsake memorialization cremation urn device.

The subject matter disclosed and claimed herein, in one embodiment thereof, comprises a smart digital touchscreen keepsake memorialization cremation urn device. The device provides an improved burial urn that is comprised of a digital display screen that can display media such as photos, videos, etc., and play songs and recordings via a speaker. The media can be transferred to the device via a physical memory card such as an SD card or may be wirelessly transferred via a mobile application. In addition, a lid of the device may be comprised of a lock that can be activated by the mobile application and or physical input to secure the contents of the device.

In this manner, the smart digital touchscreen keepsake memorialization cremation urn device of the present invention accomplishes all the foregoing objectives and provides an improved burial urn. The device also provides an improved appearance and modern design. Further, the device is equipped with modern smart features such as, but not limited to, mobile application control and electronic display screens.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart digital touchscreen keepsake memorialization cremation urn device. The device is primarily comprised of a body with at least one lid, an interior space, and at least one touch screen. The body may be any shape in the art in different embodiments. However, the body is preferably cylindrical in shape. To prevent the device from moving/sliding, the bottom surface of the body may be comprised of at least one grip structure.

The body is comprised of an opening that allows cremated ashes to be placed into the interior space of the body for storage inside the body. The opening is covered by at least one lid. The lid may attach to the body in a removable fashion. However, the lid is preferably attached to the body via at least one hinge of any type known in the art. To secure the lid to the body, the lid (and/or body) may be comprised of at least one locking mechanism.

The body is also comprised of at least one display screen. In the preferred embodiment, the display screen is a touch screen. The screen displays (without limitation) photos, videos, messages, quotes, songs, etc. Said media may relate to the ashes of the deceased individual within the device. In an embodiment wherein the screen plays a song or other recording, the sound can be played via at least one speaker of the device.

In order to allow a user to upload photos, videos, songs, recordings, etc., to the device, the device is comprised of at least one receiver slot. The slot is preferably an SD card slot, a USB slot, or any data transfer slot known in the art that allows media to be transferred onto at least one memory of the device using an SD card, USB flash drive, USB cable, etc. In a different embodiment, the device is also comprised of a mobile application for a smart device such as, but not limited to, a cell phone, a tablet, a computer, etc. Users with the mobile application can remotely upload photos, videos, recordings, etc., to the memory of the device.

The present invention is also comprised of a method of using the device. First, a device is provided comprised of a body comprised of an opening covered by at least one lid, and at least one display screen. Then, a user opens the lid of the device and places cremated ashes into an interior space of the body. Next, the user uploads media (such as, but not limited to, photos, videos, recordings, etc.) onto a memory of the device by inserting a SD card, a USB card, a data transfer cable, etc., into the receiver slot of the device. Then, the media can be configured and displayed on the touch screen by input of the touch screen or by at least one button.

The invention may also be comprised of a second method of using the device. First, a device is provided comprised of a body comprised of an opening covered by at least one lid with at least one lock, and at least one display screen. Then, a user opens the lid of the device, places cremated ashes into an interior space of the body and closes and locks the lid using the lock. Then, the user uploads media (such as, but not limited to, photos, videos, recordings, etc.) onto a memory of the device by inserting a SD card, a USB card, a data transfer cable, etc., into the receiver slot such that the media can be configured and displayed on the touch screen by input of the touch screen or by at least one button.

The present invention is also comprised of a third method of using the device. First, a device is provided comprised of a body comprised of an opening covered by at least one lid, at least one display screen, a transmitter, and a mobile application. Then, a user opens the lid of the device and places cremated ashes into an interior space of the body. Next, the user uploads media (such as, but not limited to, photos, videos, recordings, etc.) onto a memory of the device using the mobile application such that the media can be configured and displayed on the touch screen by input of the touch screen or by at least one button.

Finally, the present invention may be comprised of a fourth method of using the device. First, a device is provided comprised of a body comprised of an opening covered by at least one lid with at least one lock, at least one display screen, a transmitter, and a mobile application. Then, a user opens the lid of the device, places cremated ashes into an interior space of the body and locks the lid to the body using the mobile application to control the lock. Then, the user uploads media (such as, but not limited to, photos, videos, recordings, etc.) onto a memory of the device using the mobile application such that the media can be configured and displayed on the touch screen by input of the touch screen or by at least one button.

Accordingly, the smart digital touchscreen keepsake memorialization cremation urn device of the present invention is particularly advantageous as it provides an improved burial urn. The device also provides an improved appearance and modern design. Further, the device is equipped with modern smart features such as, but not limited to, mobile application control and electronic display screens. In this manner, the smart digital touchscreen keepsake memorialization cremation urn device overcomes the limitations of existing burial urns known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front view of one potential embodiment of a smart digital touchscreen keepsake memorialization cremation urn device of the present invention with an opened lid in accordance with the disclosed architecture;

FIG. 2 illustrates a top view of one potential embodiment of a smart digital touchscreen keepsake memorialization cremation urn device of the present invention with an opened lid in accordance with the disclosed architecture;

FIG. 3 illustrates a top perspective view of one potential embodiment of a smart digital touchscreen keepsake memorialization cremation urn device of the present invention with a closed lid in accordance with the disclosed architecture;

FIG. 4 illustrates a rear view of one potential embodiment of a smart digital touchscreen keepsake memorialization cremation urn device of the present invention with an opened lid in accordance with the disclosed architecture;

FIG. 5 illustrates a top view of one potential embodiment of a smart digital touchscreen keepsake memorialization cremation urn device of the present invention in accordance with the disclosed architecture;

FIG. 6 illustrates a graphical view of one a mobile application and the functions of the mobile application of a potential embodiment of a smart digital touchscreen keepsake memorialization cremation urn device of the present invention in accordance with the disclosed architecture;

FIG. 7 illustrates a flowchart of a method of using one potential embodiment of a smart digital touchscreen keepsake memorialization cremation urn device of the present invention in accordance with the disclosed architecture;

FIG. 8 illustrates a flowchart of a method of using one potential embodiment of a smart digital touchscreen keepsake memorialization cremation urn device of the present invention in accordance with the disclosed architecture;

FIG. 9 illustrates a flowchart of a method of using one potential embodiment of a smart digital touchscreen keepsake memorialization cremation urn device of the present invention in accordance with the disclosed architecture; and

FIG. 10 illustrates a flowchart of a method of using one potential embodiment of a smart digital touchscreen keepsake memorialization cremation urn device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved burial urn. There also exists a long-felt need in the art for a burial urn with an improved appearance and modern design. Further, there exists a long-felt need in the art for an improved burial urn that is equipped with modern smart features such as, but not limited to, mobile application control and electronic display screen. More specifically, there exists a long-felt need in the art for a smart digital touchscreen keepsake memorialization cremation urn device.

The present invention, in one exemplary embodiment, is comprised of a smart digital touchscreen keepsake memorialization cremation urn device. The device provides an improved burial urn. The device is primarily comprised of a body with at least one lid, an interior space, and at least one touch screen. The body may be any shape in the art but is preferably cylindrical in shape. To prevent the device from moving/sliding, the bottom surface of the body may be comprised of at least one grip structure.

The body is also comprised of an opening that allows cremated ashes to be placed into the interior space of the body for storage inside the body. The opening is covered by at least one lid that may attach to the body in a removable fashion. However, the lid is preferably attached to the body via at least one hinge of any type known in the art. To secure the lid to the body, the lid (and/or body) may be comprised of at least one locking mechanism.

The body is also comprised of at least one display screen. In the preferred embodiment, the display screen is a touch screen. The screen displays (without limitation) photos, videos, messages, quotes, songs, etc. Said media may relate to the ashes of the deceased individual within the device. In an embodiment wherein the screen plays a song or other recording, the sound can be played via at least one speaker of the device.

In order to allow a user to upload photos, videos, songs, recordings, etc., to the device, the device is comprised of at least one receiver slot that is preferably an SD card slot, a USB slot, or any data transfer slot known in the art that allows media to be transferred onto at least one memory of the device using an SD card, USB flash drive, USB cable, etc. In a different embodiment, the device is also comprised of a mobile application for a smart device such as, but not limited to, a cell phone, a tablet, a computer, etc. Users with the mobile application can remotely upload photos, videos, recordings, etc., to the memory of the device.

The present invention is also comprised of a method of using the device. First, a device is provided comprised of a body comprised of an opening covered by at least one lid, and at least one display screen. Then, a user opens the lid of the device and places cremated ashes into an interior space of the body. Next, the user uploads media (such as, but not limited to, photos, videos, recordings, etc.) onto a memory of the device by inserting a SD card, a USB card, a data transfer cable, etc., into the receiver slot of the device. Then, the media can be configured and displayed on the touch screen by input of the touch screen or by at least one button.

The invention may also be comprised of a second method of using the device. First, a device is provided comprised of a body comprised of an opening covered by at least one lid with at least one lock, and at least one display screen. Then, a user opens the lid of the device, places cremated ashes into an interior space of the body, and then closes and locks the lid using the lock. Then, the user uploads media (such as, but not limited to, photos, videos, recordings, etc.) onto a memory of the device by inserting a SD card, a USB card, a data transfer cable, etc. into the receiver slot such that the media can be configured and displayed on the touch screen by input of the touch screen or by at least one button.

The present invention is also comprised of a third method of using the device. First, a device is provided comprised of a body comprised of an opening covered by at least one lid, at least one display screen, a transmitter, and a mobile application. Then, a user opens the lid of the device and places cremated ashes into an interior space of the body. Next, the user uploads media (such as but not limited to photos, videos, recordings, etc.) onto a memory of the device using the mobile application such that the media can be configured and displayed on the touch screen by input of the touch screen or by at least one button.

Finally, the present invention may be comprised of a fourth method of using the device. First, a device is provided comprised of a body comprised of an opening covered by at least one lid with at least one lock, at least one display screen, a transmitter, and a mobile application. Then, a user opens the lid of the device, places cremated ashes into an interior space of the body and locks the lid to the body using the mobile application to control the lock. Then, the user uploads media (such as but not limited to photos, videos, recordings, etc.) onto a memory of the device using the mobile application such that the media can be configured and displayed on the touch screen by input of the touch screen or by at least one button.

Accordingly, the smart digital touchscreen keepsake memorialization cremation urn device of the present invention is particularly advantageous as it provides an improved burial urn. The device also provides an improved appearance and modern design. Further, the device is equipped with modern smart features such as, but not limited to, mobile application control and electronic display screens. In this manner, the smart digital touchscreen keepsake memorialization cremation urn device overcomes the limitations of existing burial urns known in the art.

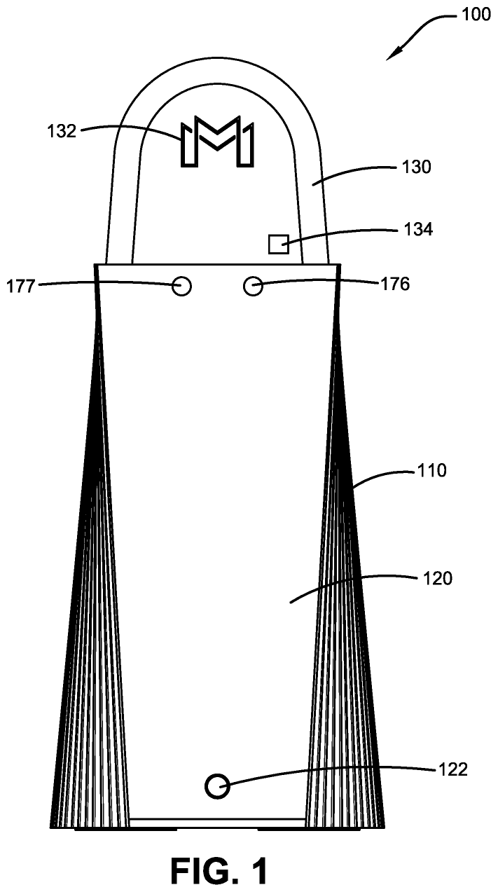

Referring initially to the drawings, FIG. 1 illustrates a front view of one potential embodiment of a smart digital touchscreen keepsake memorialization cremation urn device 100 of the present invention with an opened lid 130 in accordance with the disclosed architecture. The device 100 is primarily comprised of a body 110 with at least one lid 130, an interior space 114, and at least one touch screen 120. The body 110 may be any shape in the art in different embodiments. However, the body 110 is preferably cylindrical in shape. The body 110 may also be the shape of any type of urn known in the art. The body 110 may be made of any material such as, but not limited to, wood, plastic, metal, stone, or any material known in the art or combination thereof. The body 110 may also be any color or have any finish known in the art.

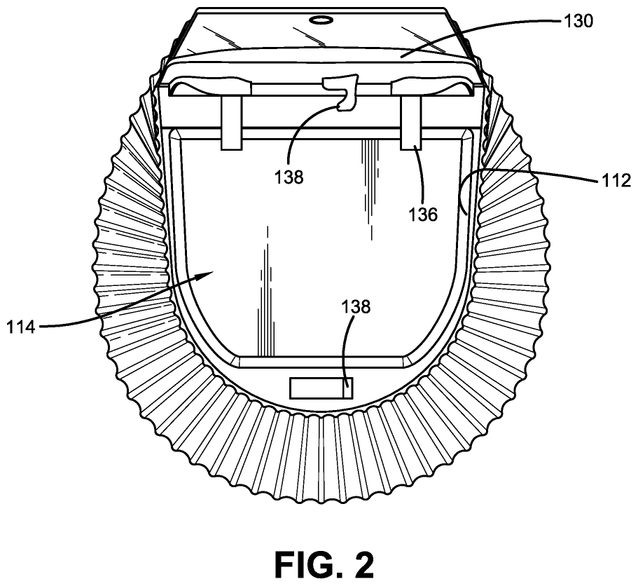

The body 110 is comprised of an opening 112 that allows cremated ashes to be placed into the interior space 114 of the body 110 for storage inside the body 110, as seen in FIG. 2. The opening 112 is covered by at least one lid 130. The lid 130 may attach to the body 110 in a removable fashion via any method known in the art such as threads, tongue and groove, etc. However, the lid 130 is preferably attached to the body 110 via at least one hinge 136 of any type known in the art. To secure the lid 130 to the body 110, the lid 130 (and/or body 110) may be comprised of at least one locking mechanism 138. The mechanism 138 may be any type known in the art such as, but not limited to, a latch, passcode lock, dial lock, Bluetooth lock, electric lock, smart lock, etc.

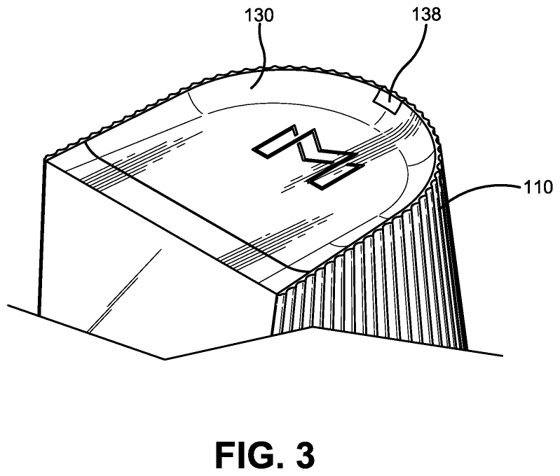

The lid 130 (and/or body 110) may be comprised of at least one indicia 132 in the form of a pattern, logo, word, number, image, photo, etc., as seen in FIG. 3. In one embodiment, the body 110 and/or lid 130 may be illuminated by at least one light 134. In one embodiment, the light 134 illuminates the lid 130 and/or interior space 114 when the lid 130 is open.

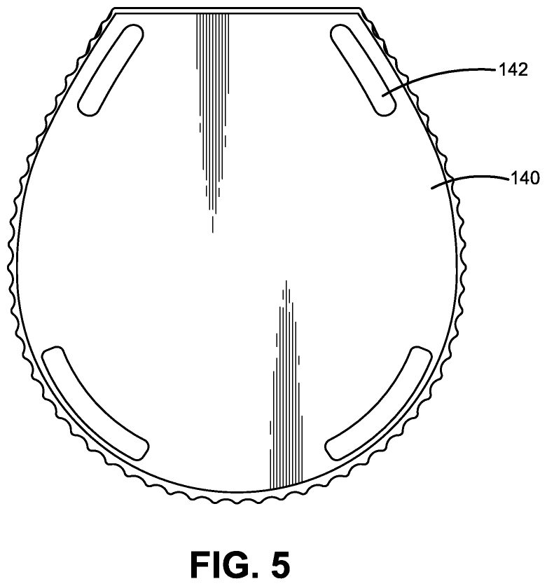

To prevent the device 100 from moving/sliding, the bottom surface 140 of the body 110 may be comprised of at least one grip structure 142, as seen in FIG. 5. The structure 142 may be comprised of a raised or recessed texture made from a rubber or other non-slip material known in the art.

The body 110 is also comprised of at least one display screen 120. In the preferred embodiment, the display screen 120 is a touch screen. However, the screen 120 may also be any electronic display screen type known in the art. The screen 120 displays (without limitation) photos, videos, messages, quotes, songs, etc., based on user input to the screen 120. Said media may relate to the ashes of the deceased individual within the device 100. In one embodiment wherein the screen 120 is not a touchscreen, the functions of the screen 120 can be controlled via at least one button 122. In an embodiment wherein the screen 120 plays a song or other recording, the sound can be played via at least one speaker 150 of the device 100. The touchscreen 120 and/or button 122 may also control the functions of the speaker 150 such as, but not limited to, volume.

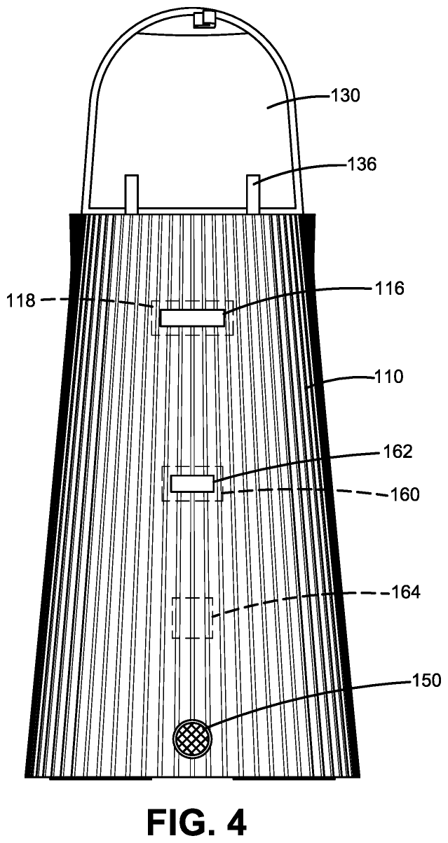

In order to allow a user to upload photos, videos, songs, recordings, etc., to the device 100, the device 100 is comprised of at least one receiver slot 116, as seen in FIG. 4. The slot 116 is preferably an SD card slot, a USB slot, or any data transfer slot known in the art that allows media to be transferred onto at least one memory 118 of the device 100 using an SD card, USB flash drive, USB cable, etc.

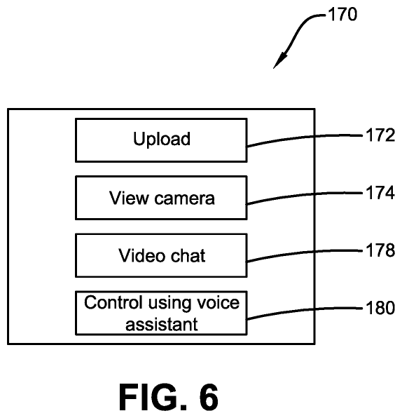

In a different embodiment, the device 100 is also comprised of a mobile application 170 for a smart device such as, but not limited to, a cell phone, a tablet, a computer, etc., as seen in FIG. 6. The mobile application 170 is in wireless electrical communication with at least one transmitter 164 of the device 100. The transmitter 164 may be any transmitter type such as, but not limited to, Bluetooth, Wi-Fi, etc. In this manner, users with the mobile application 170 can remotely upload 172 photos, videos, recordings, etc., to the memory 118 of the device 100. It should be appreciated that the mobile application 170 may also allow a user to control all functions of the device 100 that can be controlled via physical input to the device 100. This includes, but is not limited to, opening the lid 130 (via a motorized hinge), locking the lid 130 using the lock 138, controlling the touch screen 120 (i.e., what is displayed on the touch screen 120), etc. In another embodiment, the application 170 allows a user to view a camera video 174 from at least one camera 176 of the device 100. The camera 176 may be any type known in the art and can be used as a security feature. The application 170 may also allow a user to video chat 178 using the application 170, camera 176 (which may also be comprised of at least one microphone 177), and speaker 150. A user can also control all functions of the device 100 via a virtual voice assistant 180 of the mobile application 170.

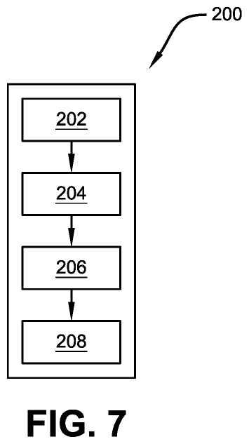

The device 100 is also comprised of at least one battery 160 that provides power to the device 100, as seen in FIG. 7. In one embodiment, the battery 160 is a removable, disposable battery. In another embodiment, the battery 160 is comprised of a rechargeable battery. In one embodiment, the battery 160 can be recharged via at least one charging port 162. The port 162 may be any charging port known in the art such as, but not limited to, a USB port.

The present invention is also comprised of a method of using 200 the device 100. First, a device 100 is provided comprised of a body 110 comprised of an opening 112 covered by at least one lid 130, and at least one display screen 120 [Step 202]. Then, a user opens the lid 130 of the device 100 and places cremated ashes into an interior space 114 of the body 110 [Step 204]. Then, the user uploads media (such as, but not limited to, photos, videos, recordings, etc.) onto a memory 118 of the device 100 by inserting a SD card, a USB card, a data transfer cable, etc., into the receiver slot 116 of the device [Step 206]. Then, the media can be configured and displayed on the touch screen 120 by input of the touch screen or by at least one button 122 [Step 208].

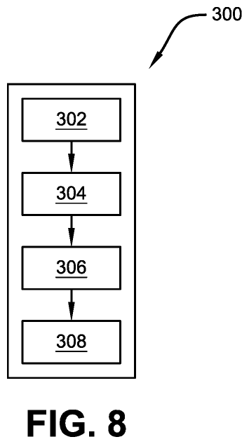

In a different embodiment, the invention is comprised of a second method of using 300 the device 100, as seen in FIG. 8. First, a device 100 is provided comprised of a body 110 comprised of an opening 112 covered by at least one lid 130 with at least one lock 138, and at least one display screen 120 [Step 302]. Then, a user opens the lid 130 of the device 100, places cremated ashes into an interior space 114 of the body 110, and then closes and locks the lid 130 using the lock 138 [Step 304]. Then, the user uploads media (such as, but not limited to, photos, videos, recordings, etc.) onto a memory 118 of the device 100 by inserting a SD card, a USB card, a data transfer cable, etc., into the receiver slot 116 of the device [Step 306]. Then, the media can be configured and displayed on the touch screen 120 by input of the touch screen or by at least one button 122 [Step 308].

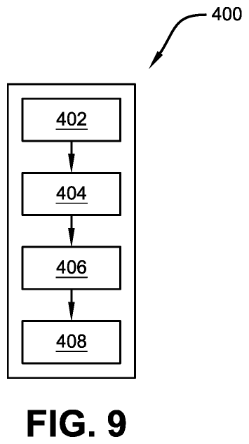

The present invention is also comprised of a third method of using 400 the device 100, as seen in FIG. 9. First, a device 100 is provided comprised of a body 110 comprised of an opening 112 covered by at least one lid 130, at least one display screen 120, a transmitter 164, and a mobile application 170 [Step 402]. Then, a user opens the lid 130 of the device 100 and places cremated ashes into an interior space 114 of the body 110 [Step 404]. Then, the user uploads media (such as, but not limited to, photos, videos, recordings, etc.) onto a memory 118 of the device 100 using the mobile application 170 [Step 406]. Then, the media can be configured and displayed on the touch screen 120 by input of the touch screen or by at least one button 122 [Step 408].

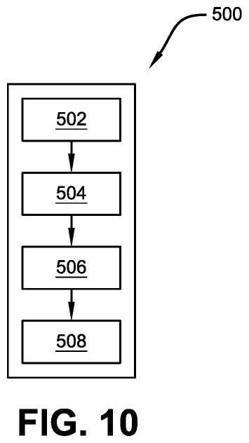

The present invention is also comprised of a fourth method of using 500 the device 100, as seen in FIG. 10. First, a device 100 is provided comprised of a body 110 comprised of an opening 112 covered by at least one lid 130 with at least one lock 138, at least one display screen 120, a transmitter 164, and a mobile application 170 [Step 502]. Then, a user opens the lid 130 of the device 100, places cremated ashes into an interior space 114 of the body 110, and then locks the lid 130 to the body using the mobile application 170 to control the lock 138 [Step 504]. Then, the user uploads media (such as, but not limited to, photos, videos, recordings, etc.) onto a memory 118 of the device 100 using the mobile application 170 [Step 506]. Then, the media can be configured and displayed on the touch screen 120 by input of the touch screen or by at least one button 122 [Step 508].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart digital touchscreen keepsake memorialization cremation urn device” and “device” are interchangeable and refer to the smart digital touchscreen keepsake memorialization cremation urn device 100 of the present invention.

Notwithstanding the forgoing, the smart digital touchscreen keepsake memorialization cremation urn device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart digital touchscreen keepsake memorialization cremation urn device 100 as shown in the FIGS. are for illustrative purposes only, and that many other sizes and shapes of the smart digital touchscreen keepsake memorialization cremation urn device 100 are well within the scope of the present disclosure. Although the dimensions of the smart digital touchscreen keepsake memorialization cremation urn device 100 are important design parameters for user convenience, the smart digital touchscreen keepsake memorialization cremation urn device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart digital touchscreen keepsake memorialization cremation urn device comprising:
a body comprised of an opening;
a lid;
a memory;
a display screen positioned on the body;
a battery; and
a speaker.

2. The smart digital touchscreen keepsake memorialization cremation urn device of claim 1, wherein the display screen is comprised of an electronic display screen.

3. The smart digital touchscreen keepsake memorialization cremation urn device of claim 1, wherein the display screen is controlled by a button.

4. The smart digital touchscreen keepsake memorialization cremation urn device of claim 1, comprised of a receiving slot.

5. The smart digital touchscreen keepsake memorialization cremation urn device of claim 4, wherein the receiving slot is comprised of an SD card slot or a USB slot.

6. The smart digital touchscreen keepsake memorialization cremation urn device of claim 2, wherein the display screen displays a photo or a video.

7. The smart digital touchscreen keepsake memorialization cremation urn device of claim 1, wherein the speaker plays a song or a sound recording.

8. A smart digital touchscreen keepsake memorialization cremation urn device comprising:
a body comprised of an opening;
a lid comprised of a locking mechanism;
a display screen positioned on the body;
a battery;
a memory;
a speaker; and
a mobile application.

9. The smart digital touchscreen keepsake memorialization cremation urn device of claim 8, wherein the display screen is comprised of a touchscreen.

10. The smart digital touchscreen keepsake memorialization cremation urn device of claim 8, wherein the lid attaches to the body via a hinge.

11. The smart digital touchscreen keepsake memorialization cremation urn device of claim 8 comprised of a light.

12. The smart digital touchscreen keepsake memorialization cremation urn device of claim 8, comprised of a wireless transmitter.

13. The smart digital touchscreen keepsake memorialization cremation urn device of claim 8, wherein the display screen displays a photo or a video.

14. The smart digital touchscreen keepsake memorialization cremation urn device of claim 8, wherein the speaker plays a song or a sound recording.

15. The smart digital touchscreen keepsake memorialization cremation urn device of claim 8, wherein the locking mechanism is comprised of an electronic lock.

16. The smart digital touchscreen keepsake memorialization cremation urn device of claim 8, wherein the display screen is controlled by the mobile application.

17. The smart digital touchscreen keepsake memorialization cremation urn device of claim 8, wherein a bottom surface of the body is comprised of a grip structure.

18. The smart digital touchscreen keepsake memorialization cremation urn device of claim 17, wherein the grip structure is comprised of a non-slip material.

19. The smart digital touchscreen keepsake memorialization cremation urn device of claim 8, wherein the battery is comprised of a charging port.

20. A method of using a smart digital touchscreen keepsake memorialization cremation urn device, the method comprising the following steps:
providing a smart digital touchscreen keepsake memorialization cremation urn device comprised of a body comprised of a display screen, a lid, and a memory;
placing a cremated ashes inside an interior space of the body;
uploading a piece of media to the memory; and
displaying the piece of media on the touch screen.
